(19) United States
(12) Patent Application Publication
(10) Pub. No.: US 2018/0054587 A1
(43) Pub. Date: Feb. 22, 2018

(54) STANDBY POWER CONTROLLER WITH IMPROVED STANDBY DETECTION

(71) Applicant: EMBERTEC PTY LTD, Dulwich, South Australia (AU)

(72) Inventor: John Haskey, Dulwich, South Australia (AU)

(21) Appl. No.: 15/555,578

(22) PCT Filed: Mar. 3, 2015
(86) PCT No.: PCT/AU2016/000063

§ 371 Date: Sep. 5, 2017

(51) Int. Cl. H04N 5/63; H04N 21/443; H04N 21/422; H04N 21/4408

(52) U.S. Cl. CPC H04N 5/63; H04N 21/4408; H04N 21/42204; H04N 21/443

(57) ABSTRACT

A standby power controller that includes a sensor that is adapted to detect usage of a set top box. The standby power controller is adapted to remove power from a television that is associated with, the set top box in the event that the sensor does not detect said usage for a selected time period, thus reducing or controlling the use of energy by television receivers and associated audio visual equipment that might be attached.

### TECHNICAL FIELD

This invention relates to a standby power controller adapted for use with a set top box (STP).

### BACKGROUND OF THE INVENTION

The following references to and descriptions of prior proposals or products are not intended to be and are not to be construed as statements or admissions of common general knowledge in the art. In particular, the following prior art discussion does not relate to what is commonly or well known by the person skilled in the art, but may assist in the understanding of the inventive step of the present invention, of which the identification of pertinent prior proposals is but one part.

There is currently world-wide concern about the level of use of electrical energy for both domestic and commercial purposes. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to the energy use of households is the audio visual equipment including multiple devices such as televisions, television decoders, television recorders and sound equipment now found in virtually all homes.

Efforts have been made to reduce or control the use of energy by television receivers and associated audio visual equipment, in particular with the use of standby power controllers, and these have met with considerable success. More advanced standby power controllers which allow energy saving beyond that which can be achieved by removing the supply of electricity when the television is in a low power standby state have been proposed. However, significant classes of audio visual installations are not compatible with these approaches.

### DISCLOSURE OF THE INVENTION

Accordingly, in a first aspect this invention provides a standby power controller including a sensor adapted to detect usage of a set top box (STB); the standby power controller adapted to remove power from a television associated with the set top box in the event that the sensor does not detect said usage for a selected time period.

In preference, the sensor detects usage of the set top box by detecting wireless signals travelling between a remote control device which controls at least some functions of the set top box and the set top box.

In preference, the sensor detects said usage by detecting a radio frequency which is used by the remote control device to communicate with the set top box.

In preference, the sensor detects said usage by detecting any usage of a wireless protocol which is used by the remote control device to communicate with the set top box.

In preference, the remote control device and the set top box communicate by use of a wireless protocol which includes pairing between devices in order to permit communication between said devices.

In preference, the sensor detects usage only when the sensor monitors signals which are signals passing between the remote control device and the set top box paired with that remote control device. The wireless protocol requires pairing in order for devices to communicate information, as, for example, to allow the remote control to control the set top box. The sensor of the invention is not paired with either the remote control device or the set top box.

In preference, the wireless protocol includes packets having an unencrypted header and an encrypted payload. The encrypted payload only being able to be shared between paired devices. A packet monitored by the sensor is able to be determined to be a communication between the remote control device and the set top box using information contained in the header without use of information contained in the payload.

Where the wireless protocol is of a type which includes an address for each device addressable by another device using the protocol and where each packet intended for processing by a device includes the address of said device in a packet header of said packet, in preference, the standby power controller is adapted to determine the address of the set top box without pairing with the set top box or any remote control device.

In preference the standby power controller determines that a monitored packet is a communication between the remote control device and the set top box by determining that an address in the packet header is the address of the set top box.

In a further embodiment, the standby power controller further adapted to detect an infra-red signal from a remote control device associated with the television.

In preference, the standby power controller will remove power from the television associated with the set top box only in the event both that the sensor does not detect usage of the set top box, and the sensor does not detect an infra-red signal from the remote control device associated with the television, for a selected time period.

In a further form, the invention may be said to lie in a sensor adapted to detect communication passing between a wireless remote control device and a set top box, said communication using a protocol requiring pairing between devices communicating using the protocol, said sensor not being paired to either device or box.

In a yet further form, the invention may be said to lie in a method for saving energy by removing power from a television of a type which displays a video signal from a set top box when said television is not being actively watched by a user including the steps of detecting use of a first wireless remote control adapted to control the set top box and determining, where said use is not detected for a selected period of time, that the user is not actively watching the television; and, upon determining that the user is not actively watching television, removing power from the television.

In preference the detecting step of the method further includes determining an address of the set top box within a wireless protocol used to communicate between the set top box and the remote control and monitoring all communications in the vicinity of the set top box which use said wireless protocol and examining address information in the monitored communications; comparing the address information to the address of the set top box and where a communication is found to include the address of the set top box, determining that use of the wireless remote control has been detected.

In preference the method includes detecting use of a second wireless remote control adapted to control the television and determining, where use of the first remote control is not detected for the selected period of time, and use of the second remote control is not detected for the selected period of time, that the user is not actively watching the television.

In preference, the sensor detects radio frequency traffic between the set top box and a remote control device associated with that set top box.

In preference, the sensor detects only said traffic directed by the remote control device to a set top box paired with that remote control, the sensor not being paired with either the set top box or the remote control device.

### BRIEF DESCRIPTION OF THE DRAWINGS

The invention will now be described with reference to certain non-limiting embodiments in connection with the accompanying drawings in which:

FIG. 1 is a representation of a standby power controller incorporating the invention.

FIG. 2a is a block diagram representation of the RF detection employed by the invention of an RF packet, used in the communication protocol between a set top box (STB) and an associated remote control.

FIG. 2b is a block diagram representation of communications between the STB and one or more remote controls, and the detection of relevant RF signals by the RF sensor of a standby power controller (SPC).

FIG. 3 is a flowchart of the operation of a standby power controller incorporating the invention.

FIG. 4 is a physical block diagram of a further embodiment of the invention.

FIG. 5 is a flowchart of the operation of an embodiment of the invention, including an IR remote control detector.

FIG. 6 is a flowchart of the operation of an embodiment of the invention, including a power sensor.

### DETAILED DESCRIPTION OF THE DRAWINGS

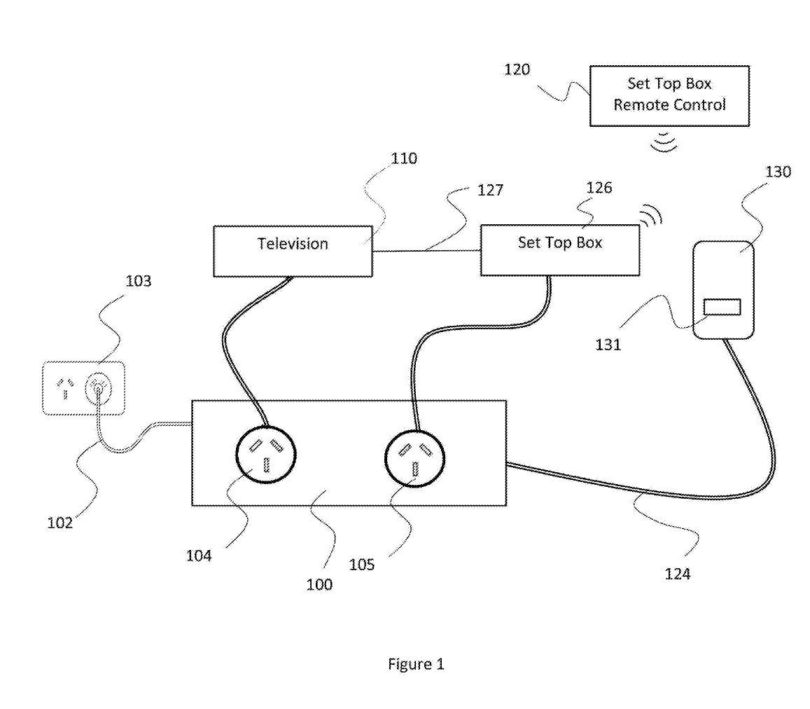

Referring first to FIG. 1, it is to be understood that this is a general representation of an installation including a standby power controller (SPC) including the invention and is illustrative only. It is not intended to limit the number or configuration of continually powered or switched or monitored main outlets, or of communication interfaces or other functional modules.

FIG. 1 shows a representation of an SPC including an embodiment of the current invention. An SPC is a device which controls the flow of electrical power to one or more connected appliances such that when one or more, or a particular one, of the connected appliances is in a “standby” state where it is not being used, the electrical power supply to one, all or selected ones of the connected appliances is interrupted. An SPC may also be known as an Advanced Power Strip (APS).

The SPC 100 receives electrical power from a General Purpose Outlet 103, via power cord 102.

The SPC includes a Controlled Outlet 104 which provides electricity to a television 110. The SPC controls the flow of electricity through the Controlled Outlet and said flow may be interrupted independently of the electricity supply from the outlet 103.

There is an Always On Outlet 105, which supplies electricity at any time when electricity is supplied to the SPC from outlet 103. The Always On Outlet may be used to power any device which requires constant power. In the illustrated embodiment, the Always On Outlet 105 provides power to a set top box 126.

The set top box 126 provides a video signal to the television 110 via data connection 127. In a preferred embodiment, the data connection is an HDMI connection. Any suitable wired or wireless connection may be used.

The set top box receives a television program signal via cable, satellite or internet connection, or any other suitable connection. The set top box decodes the received program signal and displays the video on the television. Set top box is a generic descriptor for a number of devices which perform this basic function which may be called, without limitation, such things as cable box, television decoder, satellite decoder and pay TV decoder.

There is provided a set top box remote control 120. A user uses this set top box remote control to control the set top box, to select the particular television channel to be displayed on the television. Other characteristics of the video to be displayed by the television, such as the volume of the sound may also be controlled by the set top box remote control.

The set top box remote control communicates with the set top box via radio frequency (RF) signals. Any suitable protocol may be used. In a preferred embodiment, the set top box remote control communicates with the set top box using the RF4CE protocol.

The SPC includes a sensor unit 130, which includes an RF Sensor 131. The RF Sensor is able to detect the RF communication between the set top box remote control and the set top box.

The sensor unit is shown as being in a separate housing from the base unit part of the SPC which supports the outlet connections. Functionally, the sensor unit is an integral part of the SPC 100. In other embodiments, the sensor unit may be fully integrated within the base unit of the SPC. In embodiments where there are separate housings for the base unit and the sensor unit, functional circuitry including processing and memory circuitry may be divided between the housings in any convenient manner. References to an SPC herein include the sensor, whether or not housed separately.

Modern television sets and other audio visual equipment, when turned “off” by the remote control, enter a low power “standby” state, in which energy is still consumed, although at a significantly lower level that when the device is nominally “on”. When the television or other audio visual equipment is in this standby state it is not in use, and the power supply to it may be cut to save energy, without inconvenience to a user.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy, without inconveniencing a user.

The SPC includes means to detect that a user is interacting with the set top box. The Sensor Unit 130 includes RF Sensor 131 which detects interaction between the set top box and the set top box remote control.

It is likely that a user, when actively watching television, will periodically use the remote control to change channels, adjust volume, mute commercials, etc. Thus a remote control signal receiver, such as RF Sensor 131 can be used as a usage sensor. If no remote control activity is detected by the RF Sensor 131 for a period of time, the assumption may be made that the television is not in use, and the power supply to the Controlled Outlet 104, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no remote control activity for the time period, and the television is assumed to not be in active use and the electricity supply to the Controlled Outlet 104, and hence to the television, is interrupted.

RF remote control devices have relatively long range and do not require line of sight between the remote control unit and the device to be controlled. This has the potential problem that a signal from a set top box remote control device may be able to be received by a device other than that for which the user intends to control. This can occur when there are multiple remote controllable devices in a household. It may also occur when dwellings are adjacent, as in an apartment block, and each dwelling has a similar set top box.

A solution to this problem which is generally implemented is for the signals emitted by the remote control, intended for a specific set top box, to include an identifier identifying either or both of the sending and intended recipient devices. The receiving device will then only act upon communications received which include either the identifier of the receiving device itself, or that of a known sending device to which the receiving device is intended to respond.

The set top box and set top box remote control are thus “paired”. This may be done at manufacture, and/or may be performed under user control.

The RF Sensor 131 is intended to respond only to signals passing between the set top box associated with the television to which the SPC is providing power, and its associated set top box remote control. This could be achieved by including the SPC in the “pairing” between the remote control and the set top box. This requires that a mechanism exist which allows the addition of a new device to the pairing arrangement. Further, the pairing process must be undertaken. This might require the SPC to have either or both of a keyboard and a display screen. In many cases, pairing is necessary to determine the commands being carried between the devices, since the operative parts of a signal, the payload, may be encrypted, and thus only accessible to paired devices.

The function of the RF Sensor is to detect the existence of a signal between the remote control and the associated set top box. To do this, it is only necessary to identify that a signal is passing between the two devices, the detail of the payload need not be known. The identity of the sending and receiving devices will be in the header of a signal between the devices rather than the encrypted payload. Since the header must be read by any device in order to decide if the message should be received, the header is not encrypted, and may be read by a device which is not in a pairing relationship with the set top box or the remote control.

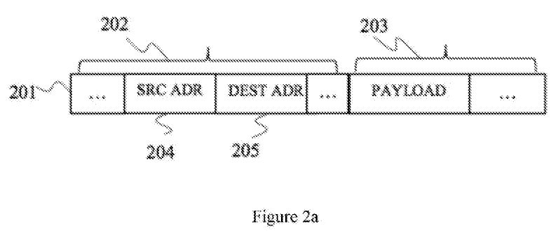

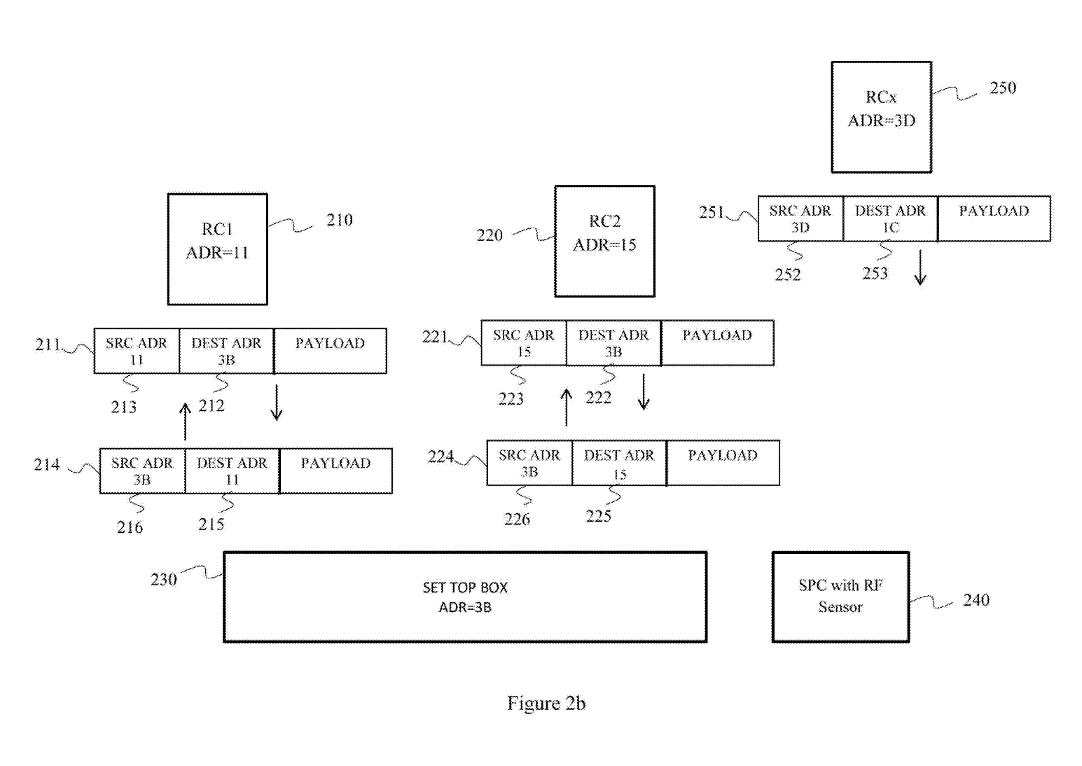

FIG. 2 is an illustration of the process by which the RF sensor identifies the signals which it should detect as indicating usage of a remote control associated with the set top box.

FIG. 2a shows a block diagram of an RF packet 201, used in the communication protocol between a set top box and an associated remote control.

The packet 201 has a packet header 202 and a payload 203. The packet header is used by devices using the protocol to determine which packets are of relevance. The packet header is not encrypted, since it must be able to be read by any device using the protocol, in order to determine if the packet is addressed to the device.

The packet 201 includes a payload 203. The payload is the command information which is to be communicated between the remote control and the set top box. It may include for example, such commands as a command to change the channel which is being displayed on an associated television, or to change the volume of the audio being played. The payload 203 is, in general, encrypted, but this is not essential.

The header 202 includes two address fields. These are SRC ADR 204 and DEST ADR 205. SRC ADR 204 is an identifier associated with the device which transmitted the packet, DEST ADR 205 is an identifier associated with the device which is intended to receive the packet, decrypt the payload, and make use of the command information.

Each device which makes use of the RF protocol has an associated identifier or address. When a packet is transmitted, the transmitting device places the address associated with itself in the SRC ADR field. The identifier of the device for which the packet is intended is placed in the DEST ADR field.

Each device using the protocol receives all protocol packets. The header is examined. Where the DEST ADR field matches a device's own address, the packet is accepted as being intended for the device. The payload is decrypted, and the command information processed.

In order to ensure that devices only act upon commands from sources which the designers of the device intend to be acted upon, and ignore spurious commands, commands directed to other devices, and malicious commands, there is a pairing process which identifies devices to each other, under user or manufacturer control.

The pairing process, and the decryption process, each require significant intelligence and computing capacity in both devices. The decryption process requires a decryption key. This requires a key exchange during the pairing process. For security reasons, barriers may be placed to prevent pairing with an unknown device.

Having the RF sensor pair with either or both of the remote control and the set top box has technical challenges, and is not necessary for the RF sensor to perform its function.

FIG. 2b shows a block diagram representation of communications between the STB and one or more remote controls, and the detection of relevant RF signals by the RF sensor of the SPC.

There is a first remote control device RC1 210. RC1 has an identifier or address of ADR=11. There is a STB 230 which has an address ADR=3B. RC1 210 is the primary remote control for the STB 230. The two devices are paired. The devices communicate by the exchange of protocol packets 211, 214.

Commands sent from RC1 to the STB are in the form of the protocol packet 211. The source address SRC ADR 213 in the protocol packet is set to 1 being the address of RC1. The destination address 212, is set to the address of the STB being 3B.

The STB replies to RC1 using packets of the form of protocol packet 214. In this case the source address SRC ADR 216 is set to the address of the STB being 3B, and the destination address DEST ADR 215 is set to the address of RC1 being 11.

In order for an SPC 240 to use an RF sensor to monitor the traffic between RC1 and the STB, the SPC must identify one or both of RC1 and the STB.

In a preferred embodiment, the SPC identifies the STB. Traffic with a DEST ADR equal to the address of the STB is determined to be relevant and detection of such traffic is indicated as RF detection by the RF sensor of the SPC 240.

In order to identify the address of the STB the SPC performs a set up operation. This need only be done once.

The SPC enters a set up mode, preferably in response to a user control operation, such as, without limitation, operation of a physical switch, or in response to a command from a software controller such as a control app.

Whilst the SPC is in set up mode, the user is instructed to operate a control on the remote control RC1 210. This causes a stream of packets 211 to be transmitted. These packets are received by the RF sensor of the SPC 240. The SPC is able to read the packet headers to determine the destination address DEST ADR 212. The SPC determines that a number of packets with identical destination address values have been received in rapid succession. This indicates that the address of the STB may be identified. The DEST ADR, in the illustrated embodiment 3B, is stored by the SPC as the relevant address, being the address of the device whose usage the SPC will monitor. Any subsequent packets received with the relevant address will be identified as relevant and the RF sensor will indicate that traffic has been detected. Traffic without the relevant address will be ignored.

The action of the SPC in identifying relevant RF traffic is illustrated by the presence of a further remote control RCx 250. RCx is a remote control using the same frequency and protocol employed by RC1 and the STB. RCx may be the remote control for another device in the same household, or a remote control used in an adjacent household. The radio signals from RCx are received by the STB 230 and by the RF sensor of the SPC 240. RCx is not paired with STB 230 and does not control the STB 230.

RCx communicates with the device which it controls by protocol packets 251. These packets are the same type of packets 211 as sent by RC1. There is a source address 252, and a destination address 253, which are unencrypted, and an encrypted payload. The destination address DEST ADR 253 is set to the value 1C, the address of the device which RCx controls.

The STB will receive the packet 251, and will read the unencrypted destination address 253 with the value 1C. This value is compared to the value of the relevant address stored by the STB during the set up phase, in this case 3B. Since the destination address 251 does not match the stored relevant address, the RF sensor will not indicate that RF has been detected, and the packet 251 from RCx will be ignored. This ensures that RF traffic which in not relevant to determining whether the STB is in use by a user is ignored.

Referring to FIG. 2b, there is optionally provided a second remote control RC2 220. This is a second remote control which is also paired with the STB 230. The address of RC2 is ADR=15. RC2 and the STB communicate by the exchange of protocol packets 221,224.

Commands sent from RC2 to the STB are in the form of the protocol packet 221. The source address SRC ADR 223 in the protocol packet is set to 15 being the address of RC2. The destination address 222, is set to the address of the STB being 3B.

The STB replies to RC2 using packets of the form of protocol packet 224. In this case the source address SRC ADR 226 is set to the address of the STB being 3B, and the destination address DEST ADR 225 is set to the address of RC2 being 15.

It can be seen that the value of DEST ADR in packet 221 is 3b, the same as for packet 211 used for communication to the STB by RC1. The relevant destination address stored by the SPC is the address of the STB being 3B. Thus, packets 224 will also be detected by the STB as being relevant packets indicating use by a user of the STB, without any further set up being required.

In an alternative embodiment, the STB may identify the remote control device during the set up phase. The STB may then detect relevant RF traffic as either or both of any traffic with a source address corresponding to RC1, and any traffic with a destination address corresponding to RC1. In this case operation of RC2, if present, will be ignored by the RF sensor.

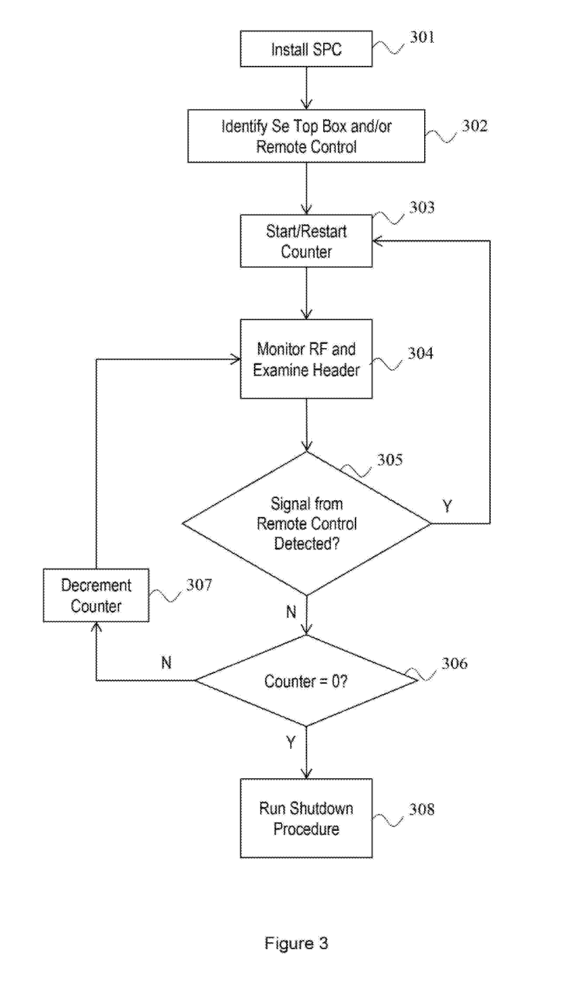

FIG. 3 is a flowchart of the operation of a standby power controller incorporating the invention.

The SPC is installed 301, providing power to a television via the Controlled Outlet. The set top box may be powered from the Always On outlet or from a separate power source.

It is necessary for the SPC to identify the set top box remote control which the RF Sensor will be detecting. This may be done by any convenient means, including direct data entry of identifying codes to the SPC. In a preferred embodiment, the SPC enters a set-up mode immediately after power up, or upon a control operation, such as pushing a button, by a user. When the SPC is in the set-up mode, the RF Sensor detects any available RF activity. The user is instructed to use the set top box remote control while the SPC is in the set-up mode. The RF Sensor detects the signal, and extracts the identifiers from the message. These identifiers are recorded and thereafter the RF Sensor will only indicate detection of RF when the detected message has those identifiers.

The SPC then commences monitoring usage of the television and set top box. The SPC starts 303 a counter to count the time during which the set top box remote control remains unused. The counter may be set to any convenient period, for example one hour. The period set may be determined at manufacture, or may be set by a user.

The RF Sensor then 304 monitors for any RF signal. Any detected signal is examined to determine if the signal includes the stored identifiers. A determination 305 is made as to whether RF from the remote control being monitored has been detected. Where such RF has been detected, this indicates that the set top box and hence the television remain in active use. The counter is reset 303 and the process repeats.

Where no RF signal is detected, a check 306 is made to check if the counter value is zero. Where the counter value is not zero, the counter is decremented 307, and the process continues 304 with the RF Sensor monitoring for RF signals.

Where the counter is determined to have reached zero, this will mean that the remote control has remained unused for a sufficient period to indicate that the television is in active standby, that is, the television is on, but is not being actively watched.

The SPC will then 308 begin the procedure to remove power from the Controlled Outlet, thus shutting down the television to save energy.

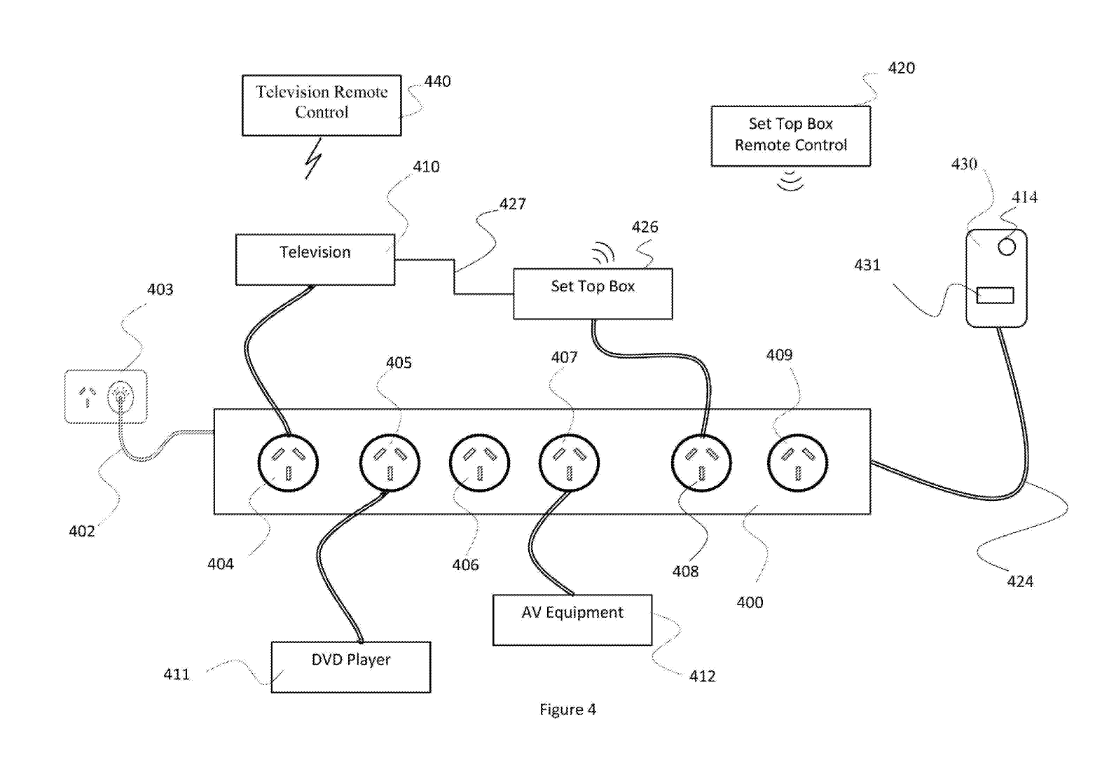

Turning to FIG. 4, there is shown a block diagram representation of a further embodiment of the invention. There is provided an SPC with multiple outlets.

The SPC 400 includes Controlled Outlets 404, 405, 406, 407. The SPC also includes Always On Outlets 408, 409. In general, any number of Controlled Outlets and Always On Outlets may be provided. In an embodiment, the Always On Outlet may be absent.

Always On Outlets provide power to devices connected to those outlets at all times when power is supplied to the SPC from the General Purpose Outlet 403.

Controlled Outlet 404 supplies electrical power to a television 410. Further Controlled Outlets 405, 406, 407 may provide electrical power to other audio-visual equipment, for example a DVD player 411 and audio equipment 412. In an embodiment having only one Controlled Outlet, multiple devices may be powered from the one outlet using a powerstrip. In any embodiment, multiple devices may be powered from one Controlled Outlet using a powerstrip.

Always On Outlet 408 provides power for a set top box 426. The set top box has a video connection 427 to the television 410. The video connection allows the set top box video output to be displayed to a user on the television. In the illustrated example, the video connection 427 is a HDMI connection. Any suitable wired or wireless protocol able to carry a video signal may be used.

There is provided a set top box remote control 420. A user uses this set top box remote control to control the set top box, to select the particular television channel to be displayed on the television. Other characteristics of the video to be displayed by the television, such as the volume of the sound may also be controlled by the set top box remote control.

The set top box remote control communicates with the set top box via radio frequency (RF) signals. Any suitable protocol may be used. In a preferred embodiment, the set top box remote control communicates with the set top box using the RF4CE protocol.

The television 410 is associated with a television remote control 440. The television remote control employs infra-red (IR) signalling to control the television.

The SPC includes a sensor unit 430, which includes an RF Sensor 331. The RF Sensor is able to detect the RF communication between the set top box remote control and the set top box. The RF sensor functions in the same way as that described in the description of FIG. 1. The Sensor Unit 430 includes an IR Sensor 414. The IR Sensor is able to detect the RF communication between the television remote control and the television.

It is likely that a user, when actively watching television, will periodically use a remote control to change channels, adjust volume, mute commercials, etc. Thus a remote control signal receiver can be used as a usage sensor.

Where both a television remote control and a set top box remote control are provided, either or both may be used by a user. Detection of usage of either remote control device is indicative that the television is in active use.

If no remote control activity, from either remote control, is detected for a period of time, the assumption may be made that the television is not in use. The television will be determined to be in an Active Standby state and the SPC acts to control a switch such that power supply to the Controlled Outlet 404, and hence to the television, is interrupted. The determination of the Active Standby state may be achieved by using a countdown timer which starts from a specific initial value equal to a particular time period, say one hour, and having this countdown time continuously decrement. Each detected use of a remote control will reset the countdown timer to the initial value. When the countdown time reaches zero, there has been no remote control activity for the time period, and the television is assumed to not be in active use and the electricity supply to the Controlled Outlet 404, and hence to the television, is interrupted.

The Sensor Unit 430 is in data communication with the body of the SPC via cable 424, which may also provide power to the sensor unit. The cable 424 may be a fixed connection or may be plug connected at one or both ends. In a further embodiment, the sensors in the Sensor Unit may be integrated in the SPC body.

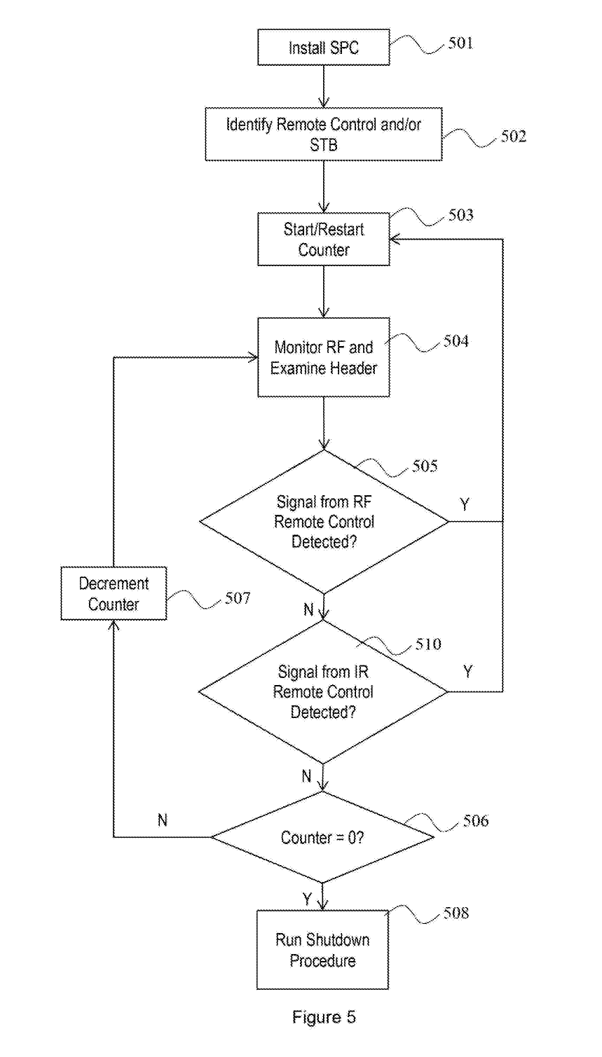

FIG. 5 is a flowchart of the function of an SPC including the invention, with IR and RF sensors as illustrated in FIG. 4.

The SPC is installed 501, providing power to a television via the Controlled Outlet. The set top box may be powered from the Always On outlet or from a separate power source.

It is necessary for the SPC to identify the set top box remote control which the RF Sensor will be detecting. This may be done by any convenient means, including direct data entry of identifying codes to the SPC. In a preferred embodiment, the SPC enters a set-up mode immediately after power up, or upon a control operation, such as pushing a button, by a user. When the SPC is in the set-up mode, the RF Sensor detects any available RF activity. The user is instructed to use the set top box remote control while the SPC is in the set-up mode. The RF Sensor detects the signal, and extracts the identifiers from the message. These identifiers are recorded and thereafter the RF Sensor will only indicate detection of RF when the detected message has those identifiers.

The SPC then commences monitoring usage of the television and set top box. The SPC starts 503 a counter to count the time during which the set top box remote control remains unused. The counter may be set to any convenient period, for example one hour. The period set may be determined at manufacture, or may be set by a user.

The RF Sensor then 504 monitors for any RF signal. Any detected signal is examined to determine if the signal included the stored identifiers. A determination 505 is made as to whether RF from the remote control being monitored has been detected. Where such RF has been detected, this indicates that the set top box and hence the television remain in active use. The counter is reset 503 and the process repeats.

Sequentially or in parallel with the check for RF activity, a check 510 is made for IR activity. This is a check for user interaction with the television via the television remote control.

A user may interact with the television via the television remote control either separately to the use of the set top box remote control, or in parallel with such use. For example, even in the presence of a set top box, the television may be receiving a separate broadcast signal.

When a user is watching programming provided by this broadcast signal, the user will use the television remote control exclusively. In another example, a user may be watching programming provided by a signal from the set top box, and will thus use the set top box remote control for such functions as channel selection. However, the user may prefer to vary the volume of the program via the television remote control.

The television is determined to be in Active Standby when no user is actively concerned with the television, as determined by interaction with the television. It can be seen that where both types of remote are in use, it is preferable to detect use of both types of remote control in order to avoid incorrect determination of Active Standby.

Where the check for IR activity indicates that IR activity has taken place, the television is in active use. The counter is reset 503 and the process repeats.

Where both checks for IR and RF activity are negative, a check 506 is made to check if the counter value is zero. Where the counter value is not zero, the counter is decremented 507, and the process continues 504 with the RF Sensor monitoring for RF signals.

Where the counter is determined to have reached zero, this will mean that the remote control has remained unused for a sufficient period to indicate that the television is in active standby, that is, the television is on, but is not being actively watched.

The SPC will then 508 begin the procedure to remove power from the Controlled Outlet, thus shutting down the television to save energy.

In an embodiment, the SPC includes a power sensor adapted to sense the power drawn through Controlled Outlet 104, 404. The power sensor detects characteristics of the power flow through the outlet. When the characteristic is such as to indicate that the television is in a standby mode the power to the Controlled Outlet 104, 404, and hence to the attached television or monitor is interrupted.

In a preferred embodiment, where there are multiple Controlled Outlets, the SPC operates to remove power from all of the Controlled Outlets together, removing power from all connected audio visual equipment which will not be in use if the television is not in use.

In a preferred embodiment, the power drawn through all of the Controlled Outlets in aggregate is monitored. Only when the characteristics of the aggregate monitored power draw indicates that all devices connected to any Controlled Outlet are in standby will power be withdrawn.

The SPC may include any number of Controlled Outlets, which may be monitored individually, in groups or in aggregate to determine characteristics of the power drawn through the outlets by the connected appliances. The power to the Controlled Outlets is controlled by the SPC and power may be withdrawn from these outlets either individually, in groups or from all Controlled Outlets simultaneously.

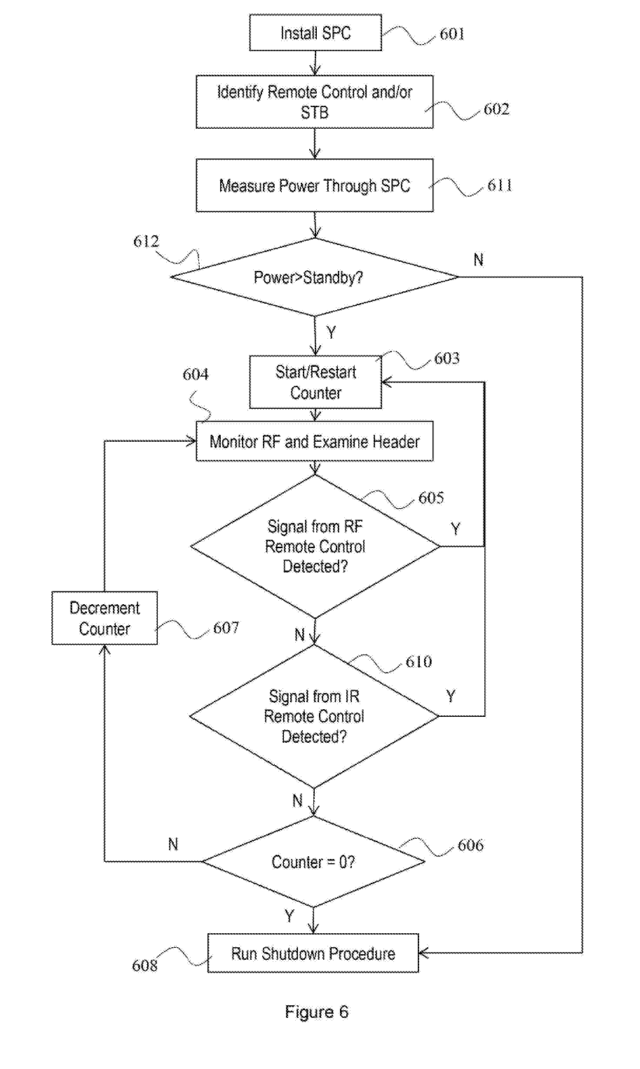

FIG. 6 is a flowchart of the function of an SPC including the invention, with IR and RF sensors, as illustrated in FIG. 4, further including a power sensor.

The SPC is installed 601, providing power to a television via the Controlled Outlet. The set top box may be powered from the Always On outlet or from a separate power source.

It is necessary for the SPC to identify 602 the set top box remote control which the RF Sensor will be detecting. This may be done by any convenient means, including direct data entry of identifying codes to the SPC. In a preferred embodiment, the SPC enters a set-up mode immediately after power up, or upon a control operation, such as pushing a button, by a user. When the SPC is in the set-up mode, the RF Sensor detects any available RF activity. The user is instructed to use the set top box remote control while the SPC is in the set-up mode. The RF Sensor detects the signal, and extracts the identifiers from the message. These identifiers are recorded and thereafter the RF Sensor will only indicate detection of RF when the detected message has those identifiers.

The SPC then commences monitoring the power usage of the television.

Modern television sets and other audio visual equipment, when turned “off” by the remote control, enter a low power “standby” state, in which energy is still consumed, although at a significantly lower level that when the device is nominally “on”. When the television is in this standby state it is not in use, and the power supply to it may be cut to save energy.

The power draw of the television is measured 611 by a power sensor associated with the Controlled Outlet 404 is used to determine the power state of the television. In an embodiment, a significant drop in the magnitude of the power draw is used to determine that a low power standby mode has been entered. Threshold values of power consumption may be used to determine the power state of the television, with any value below a threshold being determined to indicate that the television is in a standby power state. Other characteristics of the power use may be used to determine that the television is not in use. This may be the presence, absence or a defined pattern of small fluctuations of the power draw.

The characteristics of the measured power are examined 612. If the measured power is below the threshold value, or the power characteristics are such as to indicate that the television is in a low power standby mode, the SPC will commence the procedure 608 to remove power from the Controlled Outlets.

The SPC then commences monitoring usage of the television and set top box.

The SPC starts 603 a counter to count the time during which the set top box remote control remains unused. The counter may be set to any convenient period, for example one hour. The period set may be determined at manufacture, or may be set by a user.

The RF Sensor then 604 monitors for any RF signal. Any detected signal is examined to determine if the signal included the stored identifiers. A determination 605 is made as to whether RF from the remote control being monitored has been detected. Where such RF has been detected, this indicates that the set top box and hence the television remain in active use. The counter is reset 603 and the process repeats.

Sequentially or in parallel with the check for RF activity, a check 610 is made for IR activity. This is a check for user interaction with the television via the television remote control.

A user may interact with the television via the television remote control either separately to the use of the set top box remote control, or in parallel with such use. For example, even in the presence of a set top box, the television may be receiving a separate broadcast signal. When a user is watching programming provided by this broadcast signal, the user will use the television remote control exclusively. In another example, a user may be watching programming provided by a signal from the set top box, and will thus use the set top box remote control for such functions as channel selection. However, the user may prefer to vary the volume of the program via the television remote control.

The television is determined to be in Active Standby when no user is actively concerned with the television, as determined by interaction with the television. It can be seen that where both types of remote are in use, it is preferable to detect use of both types of remote control in order to avoid incorrect determination of Active Standby.

Where the check for IR activity indicates that IR activity has taken place, the television is in active use. The counter is reset 603 and the process repeats.

Where both checks for IR and RF activity are negative, a check 606 is made to check if the counter value is zero. Where the counter value is not zero, the counter is decremented 607, and the process continues 604 with the RF Sensor monitoring for RF signals.

Where the counter is determined to have reached zero, this will mean that the remote control has remained unused for a sufficient period to indicate that the television is in active standby, that is, the television is on, but is not being actively watched.

The SPC will then 608 begin the procedure to remove power from the Controlled Outlet, thus shutting down the television to save energy.

Monitoring of power state and usage of each of the types of remote control may be carried out sequentially or in parallel.

Whatever means is used to determine that the television is on, but not in use, it is unlikely to be completely free of false positives, that is, determining that the television is in active standby and not in use when the television is in fact in use. If the television is turned off when a user is still watching a program, the user will be irritated. Repeated occurrences are likely to lead to the power control function of the SPC being bypassed, preventing power savings.

There may be provided a warning LED. When the SPC determines that the television is in active standby, the warning LED will flash to alert any user to the imminent shutdown of the power to the television. In the case where there is a false positive, that is, there is a user watching the television, the user may react to observing the flashing of the warning LED by pressing a key on either the set top box remote control or the television remote control. The IR or RF signal from the remote control is detected by the sensor unit, and the countdown timer is reset, preventing the power to the television being interrupted. A separate control on the SPC such as a press button may also be provided, operation of which will also prevent shutdown.

Other methods for warning of imminent shutdown of power to the television may be used. An audible warning tone may sound.

Devices other than a television may be connected along with a television to the Controlled Outlets. In this case, the total load of all devices will be monitored for the characteristics indicating that all devices so connected are in a standby or unused state.

A third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled. When power is interrupted to the Controlled Outlets, power is also interrupted to this outlet.

Although the invention has been herein shown and described in what is conceived to be the most practical and preferred embodiments, it is recognised that departures can be made within the scope of the invention, which is not to be limited to the details described herein but is to be accorded the full scope of the disclosure so as to embrace any and all equivalent devices and apparatus.

1.-15. (canceled)

16. A standby power controller including a sensor configured to detect usage of a set top box, the standby power controller being configured to remove power from a television receiving a video signal from the set top box when the sensor does not detect usage of the set top box for a predefined time period.

17. The standby power controller of claim 16 wherein the sensor detects the usage of the set top box by detecting wireless signals traveling between:
a. a remote control device which communicates a wireless command signal to the set top box, the wireless command signal controlling a function of the set top box, and
b. the set top box.

18. The standby power controller of claim 17 wherein the sensor detects the usage of the set top box by detecting a radio signal at a frequency which is used by the remote control device to communicate the wireless command signal to the set top box.

19. The standby power controller of claim 17 wherein the sensor detects the usage of the set top box by detecting usage of a wireless communications protocol which is used by the remote control device to communicate the wireless command signal to the set top box.

20. The standby power controller of claim 17 wherein the remote control device communicates the wireless command signal to the set top box using a wireless communications protocol, the wireless communications protocol permitting communication between devices following pairing of the devices.

21. The standby power controller of claim 20 wherein:
a. the sensor detects the usage of the set top box only when the sensor detects wireless signals traveling between the remote control device and the set top box paired with the remote control device,
b. the sensor is not paired with either or both of:
(1) the remote control device, and
(2) the set top box.

22. The standby power controller of claim 21 wherein:
a. the wireless communications protocol includes a packet having:
(1) an unencrypted packet header, and
(2) an encrypted packet payload,
b. the standby power controller determines that a detected wireless signal contains a packet communicated between the remote control device and the set top box:
(1) using information contained in the packet header, and
(2) without using information contained in the packet payload.

23. The standby power controller of claim 22 wherein:
a. the wireless communications protocol:
(1) includes an address for each device addressable by another device using the protocol,
(2) each packet to be processed by a particular one of the devices includes the address of the particular device in a packet header,
b. the standby power controller is configured to determine the address of the set top box without pairing with the set top box or any remote control device.

24. The standby power controller of claim 23 wherein the standby power controller determines that a packet within a detected wireless signal is a communication between the remote control device and the set top box when an address in the packet header is an address of the set top box.

25. The standby power controller of claim 16 wherein the sensor is further configured to detect an infrared signal from a remote control device which communicates a wireless command signal to the television, the wireless command signal controlling a function of the television.

26. The standby power controller of claim 25 wherein the standby power controller is configured to remove power from the television associated with the set top box when the sensor does not detect both:
a. usage of the set top box, and
b. an infrared signal from the remote control device which communicates a wireless command signal to the television,
for a predefined time period.

27. A standby power controller:
a. including a sensor in data communication with the standby power controller, the sensor being configured to detect usage of a wireless communications protocol used to send wireless signals between:
(1) a remote control device which communicates a wireless command signal to the set top box, the wireless command signal controlling a function of the set top box, and
(2) the set top box,
the wireless communications protocol permitting communication between the remote control device and the set top box following pairing of the remote control device and the set top box,
b. wherein the sensor is not paired with either or both of:
(1) the remote control device, and
(2) the set top box.

28. The standby power controller of claim 27 wherein:
a. the wireless communications protocol includes a packet having:
(1) an unencrypted packet header including an address for each device addressable by another device using the protocol, and
(2) an encrypted packet payload,
b. the standby power controller determines that a detected wireless signal contains a packet communicated between the remote control device and the set top box using an address of the set top box contained in the packet header.

29. The standby power controller of claim 28 wherein the standby power controller determines that a detected wireless signal contains a packet communicated between the remote control device and the set top box without using information contained in the packet payload.

30. The standby power controller of claim 28 wherein the standby power controller determines that a detected wireless signal contains a packet communicated between the remote control device and the set top box without pairing with the set top box or any remote control device.

31. The standby power controller of claim 27 wherein:
a. the sensor is further configured to detect an infrared signal from a remote control device which communicates a wireless command signal to the television, the wireless command signal controlling a function of the television,
b. the standby power controller is configured to remove power from the television associated with the set top box when the sensor does not detect both:
(1) usage of the set top box, and
(2) an infrared signal from the remote control device which communicates a wireless command signal to the television,
for a predefined time period.

32. A method for saving energy by removing power from a television when the television is not being actively watched by a user, the television receiving a video signal from a set top box, the method including the steps of:
a. detecting the usage of the set top box by detecting wireless signals traveling between:
(1) a remote control device which communicates a wireless command signal to the set top box, the wireless command signal controlling a function of the set top box; and
(2) the set top box; and
b. removing power from the television when usage of the set top box is not detected for a predefined time period.

33. The method of claim 32 wherein the step of detecting the usage of the set top box further includes:
a. determining an address of the set top box within a wireless communications protocol used to communicate the wireless command signal between the set top box and the remote control;
b. monitoring communications which use the wireless communications protocol;
c. examining address information in the monitored communications;
d. comparing the address information to the address of the set top box;
e. determining that use of the wireless remote control has been detected where a monitored communication is found to include the address of the set top box.

34. The method of claim 32 further including the steps of:
a. detecting use of a second wireless remote control configured to communicate a wireless command signal to the television, the wireless command signal controlling a function of the television;
b. removing power from the television when use of both of:
(1) the first remote control, and
(2) the second remote control,
is not detected for the predefined period of time.
